(19) United States
(12) Patent Application Publication
(10) Pub. No.: US 2012/0216124 A1
(43) Pub. Date: Aug. 23, 2012

(54) BUNDLING WEB BROWSER SESSION CONTEXTS

(75) Inventors: Jacquelyn A. Martino, Cold Spring, NY (US); Paul M. Matchen, Briarcliff Manor, NY (US)

(73) Assignee: INTERNATIONAL BUSINESS MACHINES CORPORATION, Armonk, NY (US)

(21) Appl. No.: 13/030,730

(22) Filed: Feb. 18, 2011

(51) Int. Cl. G06F 3/01; G06F 15/16

(52) U.S. Cl. 715/739

(57) ABSTRACT

Bundling web browser session contexts may include aggregating a list of currently open browser web pages and presenting the list to a user. A user may select one or more browser web pages from the list. Based on the selected one or more browser web pages, a context bundle is generated and saved.

### FIELD

The present application generally relates to computer systems and more particularly to a system and method that save, restore, share multiple web browser sessions, for instance, to maintain contexts of workflow.

### BACKGROUND

A web browser is a user interface application that enables users to access files over the Internet from web sites. Current browsers allow a user to save and restore one browser session state upon closing the browser application. There is no user control beyond what is currently open in the browser session. Frequently, however, the user is exploring a variety of web sites that may not all be conceptually part of a single workflow or context. While known browsers include browser history listing the previously visited sites, the history file does not help in identifying which web sites or web pages might have similar context or could be used in similar context.

### BRIEF SUMMARY

A method and system for bundling web browser session contexts may be provided. The method, in one aspect, may include aggregating a list of currently open browser web pages and presenting the list to a user. The method may also include allowing a user to select one or more browser web pages on the list and receiving selected one or more browser web pages. The method may further include generating a context bundle based on the selected one or more browser web pages, and storing the context bundle.

A system for bundling web browser session contexts, in one aspect, may include a user interface module operable to interact with a user. A context bundle module may be operable to aggregate a list of currently open browser web pages and present the list to a user via the user interface module. The context bundle may be further operable to receive selected one or more browser web pages and generate a context bundle based on the selected one or more browser web pages.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating a method for bundling websites or web pages.

FIG. 2 illustrates a method in one embodiment of the present disclosure for searching across as a bundle of websites.

FIG. 3 is a block diagram illustrating system components in one embodiment of the present disclosure.

FIG. 4 illustrates an example of grouping of web pages in a context bundle.

FIG. 5 illustrates content of a context bundle in one embodiment of the present disclosure.

### DETAILED DESCRIPTION

A system and method may be provided in one embodiment that allow a user to explicitly and on demand select subsets (multiples) of a browser session and/or items from history and/or from bookmarks to save, restore, share session information as a context. Briefly, a browser is a user interface that retrieves data such as documents from a specified Web site and displays and/or otherwise presents the retrieved data to a user, for example, in a browser window. A browser session starts when a browser is started for execution on a computer and ends when the browser is closed, i.e., stops executing.

In one embodiment of the present disclosure, a system and/or method allows a user to specify one or more elements of a browser session, e.g., Uniform Resource Identifiers (URIs), e.g., Uniform Resource Locators (URLs), from open windows or tabs, bookmarked URIs, URIs from history folder, and other, and bundle them to save, restore, and share a particular workflow or context. The system and/or method of the present in one embodiment provide the ability to control what gets bundled and the ability to share the bundle.

For example, a user may open one or more browser windows or tabs during a browser session, e.g., the Internet or the World Wide Web browsing session. On user request, a system (or method) of the present disclosure in one embodiment may present a visual list of all open browser windows and/or tabs in the current session. The system may optionally list items from user browsing history or bookmarks associated with the user, for example, saved on the user's computer. The user may select a plurality of elements to save as a browser session context bundle. The user may be also provided with an option to annotate the browser session context bundle. A user may be given an option to name the context bundle, and/or the system may automatically provide a default name. The system of the present disclosure in one embodiment names and saves the context bundle. The system may also save state data (e.g., cookies) associated with the context bundle. For instance, a user may be given an option to select whether to save the cookies. The saved context bundle may include a list of URIs (or e.g., URLs) of the web pages and one or more cookies (data stored by the web site of those pages, typically a file).

At some point after the context has been saved, the user may access or restore the saved context bundle, i.e., redisplay or reopen the web pages saved in the context bundle. The context bundle may be also uploaded to a cloud and/or shared among a group of users.

The system and method of the present disclosure in one embodiment may be implemented as a plug-in to an existing browser, and may be executed upon selecting a tool button or the like on the browser.

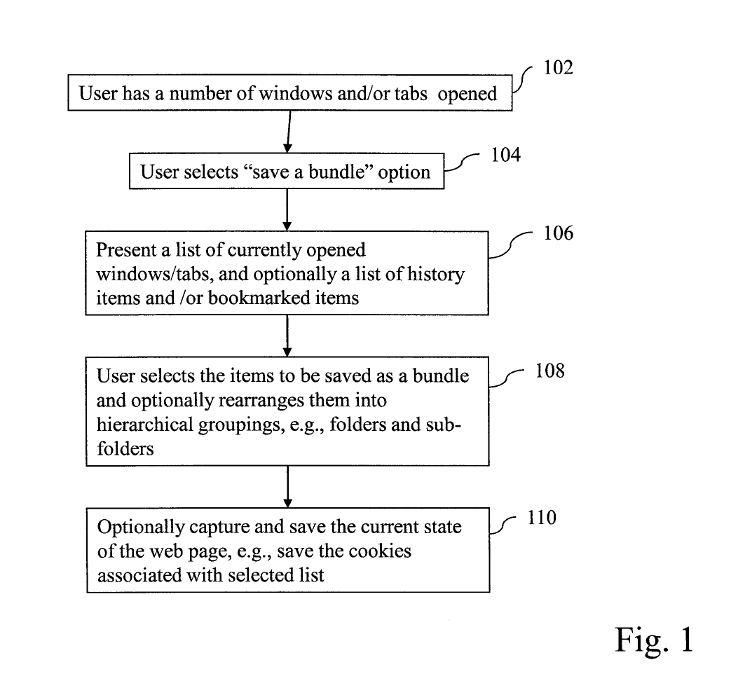

FIG. 1 is a diagram illustrating a method for bundling websites or web pages. At 102, browser software has a number of web pages opened. For example, a user has executed the browser on a computer and accessed multiple web pages on different windows or tabs. The browser software includes an option to “save as a bundle”, which the user may select to create and save a context bundle. At 104, selection of the option is detected. The browser software in response may execute a module to start the method of the present disclosure in one embodiment. At 106, a list of currently opened web pages and optionally, a list of items which the user has accessed in the past and/or a list of bookmarked items are presented to the user, for example, as a pop-up menu list. Any other user interface presentation methodology may be employed for presenting the list. The list of items which the user has accessed in the past may be retrieved from a history file, a file that includes the web sites the user has visited previously. A bookmarked list includes web pages that the user has saved or bookmarked, for example, as being a favorite site. A bookmarked list may be also retrieved from a file or profile that has been saved, for instance, on the user's computer or on a remote computer.

At 108, the user may then select from the list of items (web page URIs or other identifiers) presented, the items the user would like to save as a context bundle. The system and method of the present disclosure also may provide the user with an option to rearrange the selected items into subgroups. The subgroups may be arranged hierarchically, having a root and leaf nodes. An item may belong to more than one subgroup.

At 110, the system and/or method of the present disclosure receive the selected list, and capture the current state of the web pages in the list. The current state of the web pages is saved in the context bundle. For instance, the cached content of the web pages that is currently shown in the browser window may be saved. When the saved bundle is opened later, a user is able to view that content as it was shown at the time of the save. In addition, cookie files associated with the web pages may be also saved. For instance, the cookies associated with the web pages being bundled may have been stored in associated directories/folders. Those cookies may be also saved.

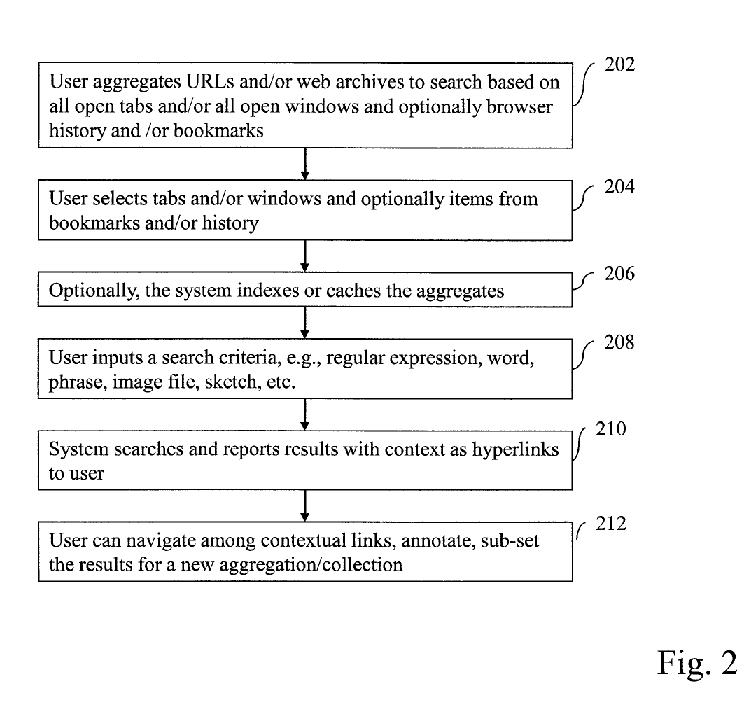

In another aspect of the present disclosure, searching may be performed on a bundle of websites. The search may be performed across the current bundle opened in the browser, and/or across the previously saved bundle of websites. FIG. 2 illustrates a method in one embodiment of the present disclosure for searching across a bundle of websites. At 202, a user may aggregate URLs (or URIs) and/or web archives to search based on all open tabs and/or all open windows. Optionally, the URLs (or URIs) from browser history and/or bookmarks may be aggregated. The aggregated list is presented to the user, for example, displayed, and a user is enabled to select one or more URLs from the list, and also to input search criteria, e.g., one or more search terms or expressions.

At 204, a user selects tabs and/or windows and optionally items from bookmarks and/or history. Optionally, at 206, the methodology of the present disclosure may automatically index or cache one or more URLs from the list. At 208, a user may enter search criteria, which the methodology of the present disclosure receives and acts upon. The search criteria may be, for example, regular expression, a word or a set of words, phrase, image file, sketch, and/or others.

At 210, the methodology of the present disclosure in one embodiment searches the content of the URL pages selected by the user, using the user entered search criteria. The search may include all content, including the meta-data and any other data in the pages of the URLs which are not directly observable by the user, e.g., non-displayed data, as well as the displayed data. The methodology of the present disclosure may present the results of the search. The result may include the URLs, content of the URLs or portions thereof where the search criteria occur in the content. The result may also include the bundle context, e.g., as a hyperlink, in which the one or more resultant URLs belong to or is grouped with. A URL may belong to more than one context. Providing a hyperlink to a bundled context would allow a user to navigate to other URLs in the hyperlinked context.

At 212, the user may be enabled to navigate among the one or more context hyperlinks, annotate, or make a subset of the result for a new aggregation or collection.

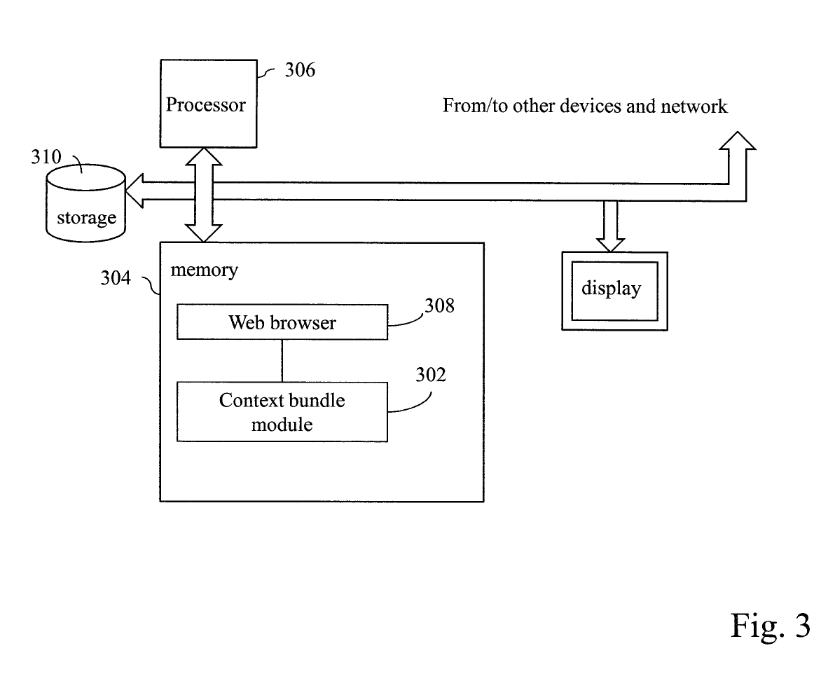

FIG. 3 is a block diagram illustrating system components in one embodiment of the present disclosure. A module 302 for context bundling of the present disclosure in one embodiment may be loaded into computer system memory 304 and executed by a processor 306. The module 302 may be part of browser software 308 or a plug-in. A generated context bundle according to the method of the present disclosure in one embodiment may be stored on a permanent storage 310 local to the processor 306. In another embodiment, the context bundle may be transmitted over a network and stored remotely on a remote system.

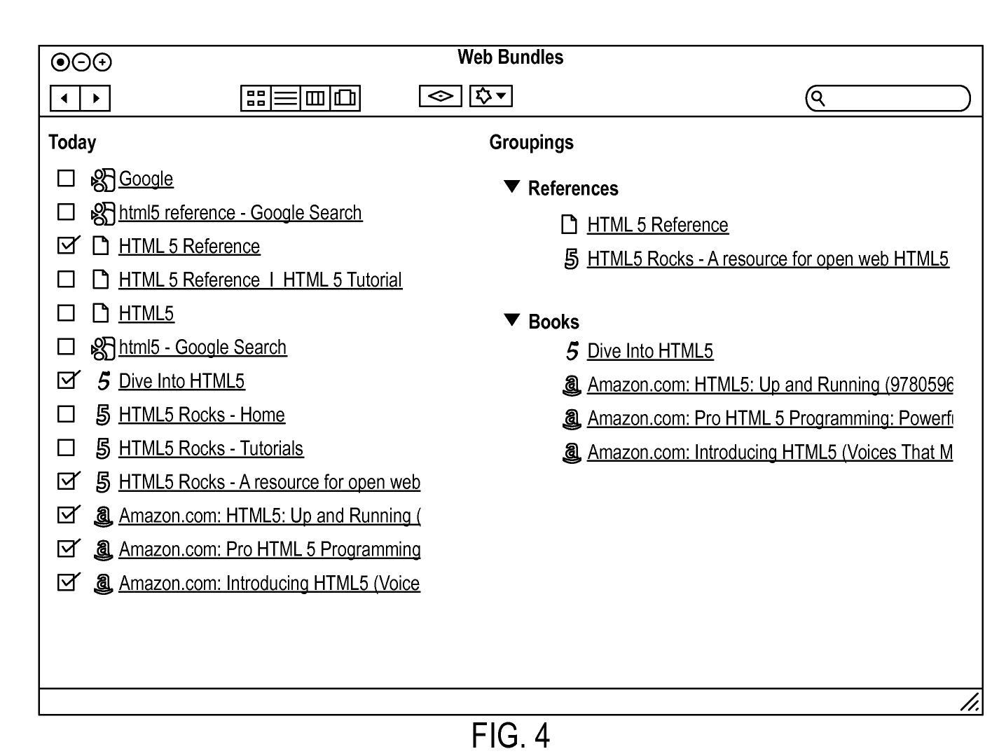

FIG. 4 illustrates an example of grouping of web pages in a context bundle. For instance, as described above with reference to FIG. 1 at 108, a context bundle may include a list of web pages grouped into subgroups. In FIG. 4, a context bundle may include those pages selected (check marked in the left hand column) by a user. Further those selected pages may be grouped in subgroups as shown in the right hand column of the screen, in this example, “References” and “Books”.

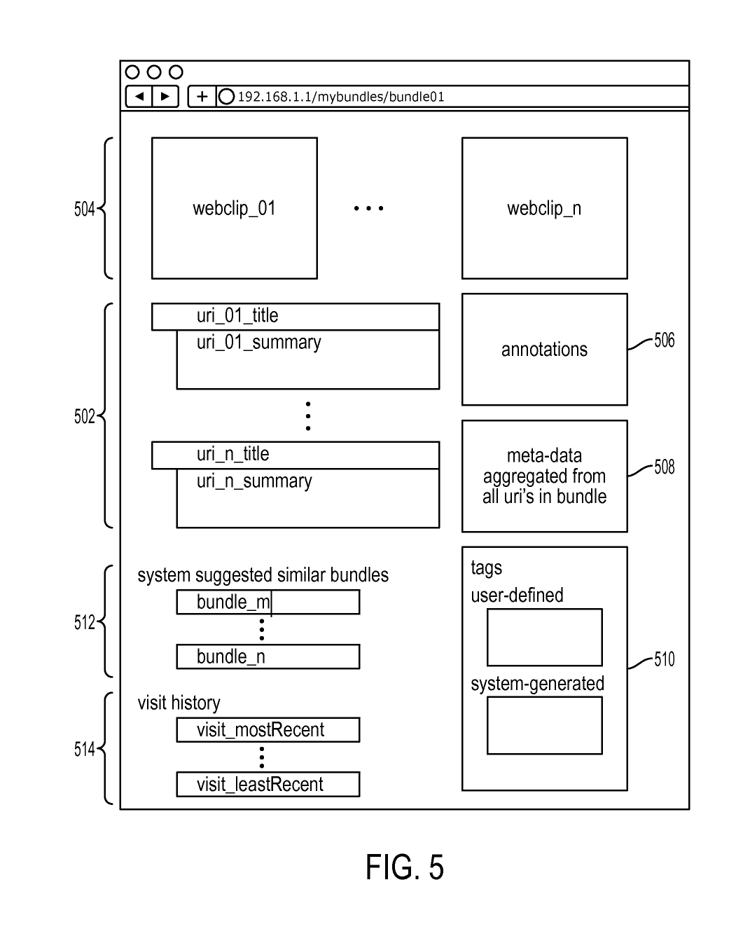

FIG. 5 illustrates content of a context bundle in one embodiment of the present disclosure. A context bundle may include a list of URI(s) 502 or identifier(s) that identify a resource or web page. The list of URIs 502 may include the name or title of the URIs and/or summary information associated with the URIs. The context bundle may also include web clippings 504 or contents (or portions of contents) of those pages identified by the URIs 502. The context bundle may further include annotations 506 about those pages. Annotations 506 may be notes or comments related to the pages in the context bundle and/or about the context bundle, information about the context bundle and other information. The context bundle may also include tags 510, user generated or system generated or both, associated with the context bundle and/or URIs in the context bundle. User generated tags may be classification words that are meaningful to a specific user. System generated tags may be derived based on the context in which the URIs were added or the document's actual contents by using, e.g., lexical word finding and/or density algorithms. The tags 510 may be used for search and/or classification purposes. For example, tags may be used for tag cloud visualization.

The context bundle may further include meta-data aggregated from the URIs 508 in the bundle. Meta-data includes information about the data contained in the URI pages. Examples of meta-data may include author information, publication date, creation date, modification date, number of characters, words, and/or pages in a document, image resolution, image color-depth, and other information. In one embodiment, the meta-data may be collected and/or stored in one file. The meta-data can be used to classify bundles and/or sort them in a variety of ways, e.g., by timestamp, by update frequency, by author proliferation, by size, and others.

In addition, the context bundle may include one or more names or identifications of other context bundles 512 determined to be similar to the current context bundle or likewise related to the currently context bundle. The context bundle may also include visit history 514 that indicates which web pages or URIs were most recently, least recently, most frequently and/or least frequently visited.

In one embodiment, in performing the search described above with reference to FIG. 2, the methodology of the present disclosure may search the contents of a plurality of context bundle, for example, shown in FIG. 5, e.g., the URIs and summary 502, web clippings 504, annotations 506, meta-data 508, tags, 510, and/or visit history 514. In another embodiment, the scope of the search may include searching the full content of the web pages identified by the URIs in the context bundle. In another embodiment, the scope of the search may include the web clippings 504 stored in the bundle.

The context bundle of the present disclosure allows a group of web pages to be operated on as one group or one file, for example, all web pages grouped together may be searched as one document.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for bundling web browser session contexts, comprising:
aggregating a list of currently open browser web pages;
presenting the list to a user;
allowing a user to select one or more browser web pages on the list;
receiving selected one or more browser web pages;
generating a context bundle based on the selected one or more browser web pages; and
storing the context bundle.

2. The method of claim 1, further grouping the selected one or more web pages into hierarchical subgroups.

3. The method of claim 1, further including:
providing an option in a browser interface to bundle a plurality of web pages, wherein the steps of claim 1 are performed in response to a user selecting the option.

4. The method of claim 1, further including:
aggregating one or more items from a browser history file containing previously accessed web pages, wherein the list presented to the user further includes the one or more items to the browser history file.

5. The method of claim 1, further including:
aggregating one or more bookmarked items, wherein to the list presented to the user further includes the one or more bookmarked items.

6. The method of claim 1, further including:
storing one or more cookies associated with the selected one or more browser web pages as a context bundle.

7. The method of claim 1, further including:
transmitting the context bundle over a network to another user.

8. The method of claim 1, further including:
restoring the context bundle by opening and displaying the selected one or more browser web pages.

9. The method of claim 1, further including:
searching a plurality of context bundles to select a context bundle to restore.

10. The method of claim 1, wherein the context bundle includes identifiers of the selected web pages, and one or more of summary of the selected web pages, web clippings associated with the selected web pages, annotations associated with the context bundle, meta-data aggregated from the selected web pages, tags associated with the context bundle, a list of one or more other context bundles determined to be related to the context bundle, or visit history of the selected web pages, or combinations thereof.

11. A system for bundling web browser session contexts, comprising:
a processor;
a user interface module operable to interact with a user;
a context bundle module operable to aggregate a list of currently open browser web pages and present the list to a user via the user interface module, the context bundle further operable to receive selected one or more browser web pages and generate a context bundle based on the selected one or more browser web pages.

12. The system of claim 11, further including:
a storage device storing the context bundle.

13. The system of claim 11, wherein the context bundle module is further operable to group the selected one or more web pages into hierarchical subgroups.

14. The system of claim 11, the user interface module provides an option to bundle a plurality of web pages, wherein the context bundle module performs its operations in response to a user selecting the option.

15. The system of claim 11, wherein the context bundle module aggregates one or more items from a browser history file containing previously accessed web pages, wherein the list presented to the user further includes the one or more items to the browser history file.

16. The system of claim 11, wherein the context bundle module aggregates one or more bookmarked items to the list, wherein the list presented to the user further includes the one or more bookmarked items.

17. The system of claim 11, wherein the context bundle further stores one or more cookies associated with the selected one or more browser web pages.

18. The system of claim 11, wherein the context bundle further transmits the context bundle over a network to another user.

19. The system of claim 11, wherein the context bundle includes identifiers of the selected web pages, and one or more of summary of the selected web pages, web clippings associated with the selected web pages, annotations associated with the context bundle, meta-data aggregated from the selected web pages, tags associated with the context bundle, a list of one or more other context bundles determined to be related to the context bundle, or visit history of the selected web pages, or combinations thereof.

20. A computer readable storage medium storing a program of instructions executable by a machine to perform a method for bundling web browser session contexts, comprising:
aggregating a list of currently open browser web pages;
presenting the list to a user;
allowing a user to select one or more browser web pages on the list;
receiving selected one or more browser web pages;
generating a context bundle based on the selected one or more browser web pages; and
storing the context bundle.

21. The computer readable storage medium of claim 20, further grouping the selected one or more web pages into hierarchical subgroups.

22. The computer readable storage medium of claim 20, further including:
providing an option in a browser interface to bundle a plurality of web pages, wherein the steps of claim 1 are performed in response to a user selecting the option.

23. The computer readable storage medium of claim 20, further including:
aggregating one or more items from a browser history file containing previously accessed web pages, wherein the list presented to the user further includes the one or more items to the browser history file.

24. The computer readable storage medium of claim 20, further including:
aggregating one or more bookmarked items, wherein to the list presented to the user further includes the one or more bookmarked items.

25. The computer readable storage medium of claim 20, wherein the context bundle includes identifiers of the selected web pages, and one or more of summary of the selected web pages, web clippings associated with the selected web pages, annotations associated with the context bundle, meta-data aggregated from the selected web pages, tags associated with the context bundle, a list of one or more other context bundles determined to be related to the context bundle, or visit history of the selected web pages, or combinations thereof.
